(19) United States
(12) Patent Application Publication
(10) Pub. No.: US 2019/0197638 A1
(43) Pub. Date: Jun. 27, 2019

(54) METHOD, DEVICE AND SYSTEM FOR DETERMINING A DEVELOPMENT PLAN FOR AN AREA

(71) Applicant: MASTERCARD INTERNATIONAL INCORPORATED, Purchase, NY (US)

(72) Inventors: Rabia Aslam, Gurgaon (IN); Rajesh Chopra, Gurgaon (IN); Priyanshu Sawalka, Ranchi (IN); Tanika Gupta, Gurgaon (IN); Ganesh Shankar Rai, Chattarpur (IN); Ankur Dua, Rohtak (IN); Surbhi Chetwani, New Delhi (IN)

(21) Appl. No.: 16/225,525

(22) Filed: Dec. 19, 2018

(30) Foreign Application Priority Data
Dec. 22, 2017 (SG) 10201710765X

(51) Int. Cl. G06Q 50/16; G06Q 20/38; G06Q 20/08; H04W 4/021

(52) U.S. Cl. CPC G06Q 50/165; H04W 4/021; G06Q 20/08; G06Q 20/389

(57) ABSTRACT

A method for determining a development plan for an area includes receiving input parameters associated with a plurality of target geographical areas and a reference geographical area; identifying, based on the input parameters, a candidate geographical area matching the reference geographical area from the plurality of target geographical areas; and determining a development activity for the candidate geographical area based on an outcome of said development activity in the reference geographical area. Devices and systems for determining a development plan for an area are also disclosed

### CROSS-REFERENCE TO RELATED APPLICATION

This application claims the benefit of and priority to Singapore Patent Application No. 10201710765X filed Dec. 22, 2017. The entire disclosure of the above application is incorporated herein by reference.

### FIELD

The present disclosure generally relates, broadly, but not exclusively, to methods, devices and systems for determining a development plan for an area.

### BACKGROUND

This section provides background information related to the present disclosure which is not necessarily prior art.

City development is a costly task. It is not trivial to decide where best to invest money for city development.

Government agencies for all countries invest in infrastructure development and make strategies for both short and long terms. These strategies may include redevelopment of a city's infrastructure in terms of residential/commercial/pubic properties to convert a normal city to a smart city, or development of city outskirts and undeveloped areas, etc.

For example, the government may plan a road map to develop city A into a smart city based on political reasons, but fails to implement the strategies due to lack of public demand for infrastructure investment. In another example, the government plans on installing intelligent street lamps which adapt to movement by pedestrians in a busy locality B. This turns out to be a wasteful investment of resources, as the locality remains busy round the clock and the street lamps are always on. In other words, regular street lights would work fine for locality B. On the other hand, there may be a mostly inactive locality C where these intelligent street lamps are not installed and there is wastage of energy, as the regular street lights used at locality C are always on. These two exemplary situations highlight the importance of micro-level knowledge for policy making.

While governments mostly have a macro-view, they rely on local representatives to give a micro-level view for taking infrastructure investment-related decisions. Such sources of information may be biased based on political will, lobbies and interest groups, etc. They also may not reflect the true public demand for such infrastructure services.

A need therefore exists to assist government agencies with development strategies.

### SUMMARY

This section provides a general summary of the disclosure, and is not a comprehensive disclosure of its full scope or all of its features. Aspects and embodiments of the disclosure are set out in the accompanying claims.

An aspect of the present disclosure provides a method for determining a development plan for an area. The method includes receiving input parameters associated with a plurality of target geographical areas and a reference geographical area; identifying, based on the input parameters, a candidate geographical area matching the reference geographical area from the plurality of target geographical areas; and determining a development activity for the candidate geographical area based on an outcome of said development activity in the reference geographical area.

Another aspect of the disclosure provides a device for determining a development plan for an area. The device includes a receiver configured to receive input parameters associated with a plurality of target geographical areas and a reference geographical area, wherein the receiver is in communication with a database storing payment card data; an identification circuit configured to identify, based on the input parameters, a candidate geographical area matching the reference geographical area from the plurality of target geographical areas; and a determination circuit configured to determine a development activity for the candidate geographical area based on an outcome of said development activity in the reference geographical area.

Another aspect of the disclosure provides a system for determining a development for an area. The system includes a processor and a memory unit in communication with the processor. The memory unit is configured to receive input parameters associated with a plurality of target geographical areas and a reference geographical area. The processor is configured to identify, based on the input parameters, a candidate geographical area matching the reference geographical area from the plurality of target geographical areas; and determine a development activity for the candidate geographical area based on an outcome of said development activity in the reference geographical area.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments and implementations are provided by way of example only, and will be better understood and readily apparent to one of ordinary skill in the art from the following written description, read in conjunction with the drawings, in which:

FIG. 1 shows a flow diagram illustrating a method of determining a development plan for an area according to an example embodiment;

FIG. 2 shows a table of input parameters or variables in an example scenario;

FIG. 3 shows a graph related to a normalization function;

FIG. 4 shows a table listing a set of distinguishing parameters and their respective coefficients for the regression model;

FIG. 5A shows a table of unsorted scores, while FIG. 5B shows a table of sorted scores;

FIG. 6 shows a table matching shortlisted cities with reference cities;

FIG. 7 shows a schematic diagram illustrating a device for determining a development plan for an area according to an example embodiment; and

FIG. 8 depicts an exemplary computing device suitable for implementing the method and system according to various embodiments.

Corresponding reference numerals indicate corresponding parts throughout the several views of the drawings.

### DETAILED DESCRIPTION

### Overview

Embodiments of the present disclosure will be described, by way of example only, with reference to the drawings. The description and specific examples included herein are intended for purposes of illustration only and are not intended to limit the scope of the present disclosure.

According to various embodiments, it is appreciated that payment card data (for example, transaction data from servers maintained by a payment card network, such as Mastercard®) may provide a rich micro-level view for optimizing decision making in respect of infrastructure development. The present methods and systems provide a strategy development platform based on such data to help government agencies to (a) identify potential area(s) for infrastructure development, and (b) select the direction in which to develop the infrastructure.

In a first part, the platform may use anonymized payment card transaction data of customers from different locations or areas to provide a composite score or index which, based on multiple factors, may indicate the readiness or need of an area in terms of its development. It may also allow benchmarking one area to another, which can help in prioritizing, since development resources may be limited.

Some non-limiting factors or parameters to be considered in developing the composite score are: (i) industry-wise spend, (ii) industry-wise transactions, (iii) trends on how has industry spend grown over a period of time as the city has expanded, (iv) day of the week spend, (v) time of the day spend, (vi) affluence of residents, (vii) year over year growth in affluence, (viii) online channel growth, (ix) spend radius on how far does someone travel and for which industry.

In a second part, once the correct area has been identified for development, the platform may give a ranking of the set of infrastructure developments that can be implemented. This may be done by comparing the identified area A in time period T with at least one look-alike area B in time period T-1 and then trace the development of such area B to predict the likeliness of success of the infrastructure development if implemented in area A.

In other words, a development plan for an area may be created to emulate a success of such a plan at another area based on real-world commercial data, rather than statistics from local representatives which may be biased. Advantageously, selection of an area for development can be done more objectively and development resources can be used more optimally.

### Terms Description (in Addition to Plain and Dictionary Meaning of Terms)

A variable (which may also be referred to as a “parameter”) may be a value, which may be a real number, and integer number, a Boolean value (i.e., a true/false value), and may refer to an economic value of a city or a resident of the city or of a person doing business in that city. For example, a parameter may be data collected from usage of payment cards, for example credit cards, and may, for example, include one or more of the following: industry-wise spend, industry-wise transactions, trends on how has industry spend grown over a period of time as the city has expanded, day of the week spend, time of the day spend, affluence of residents, year over year growth in affluence, online channel growth, and spend radius on how far does someone travel and for which industry.

A geographical area refers to a region which may be administratively defined. Non-limiting examples of a geographical area are a city, a town, a district, a neighborhood, a street, etc.

According to various embodiments, a target geographical area may be a potential area for which it is to be determined how to best develop, for example, on what to invest money, and how much money should be invested for which investment purpose. Development can be infrastructure development, e.g., provision of amenities, incorporation of intelligent systems, etc. There can be multiple target geographical areas, and a candidate geographical area is one identified by the present method and system as suitable for development.

According to various embodiments, a reference geographical area may be an area that has already been developed, for example, a city into which money has already been invested for development, and the outcome of such investment or development, e.g., whether a success, can be ascertained.

A payment card may be any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. In other words, in some instances, such a payment card may not exist in a physical form, but rather, may be in an electronic form comprising data stored in a digital (i.e., mobile) wallet.

Transaction data may be data collected by a payment card network, such as Mastercard®, during an electronic transaction involving a payment card, and may include transaction level information (e.g., Transaction ID, Account ID (anonymized), Merchant ID, Transaction Amount, Transaction Local Currency Amount, Date of Transaction, Time of Transaction, Type of Transaction, Date of Processing, Cardholder Present Code Merchant Category Code (MCC)), Account Information (e.g., Account ID (anonymized), Card Group Code, Card Product Code, Card Product Description, Card Issuer Country, Card Issuer ID, Card Issuer Name, Aggregate Card Issuer ID, Aggregate Card Issuer Name), Merchant Information (e.g., Merchant ID, Merchant Name, MCC/Industry Code, Industry Description, Merchant Country, Merchant Address, Merchant Postal Code, Aggregate Merchant ID, Aggregate Merchant Name, Merchant Acquirer Country, Merchant Acquirer ID), and Issuer Information (e.g., Issuer ID, Issuer Name, Aggregate Issuer ID, Issuer Country).

### Exemplary Embodiments

Embodiments will be described, by way of example only, with reference to the drawings. Like reference numerals and characters in the drawings refer to like elements or equivalents.

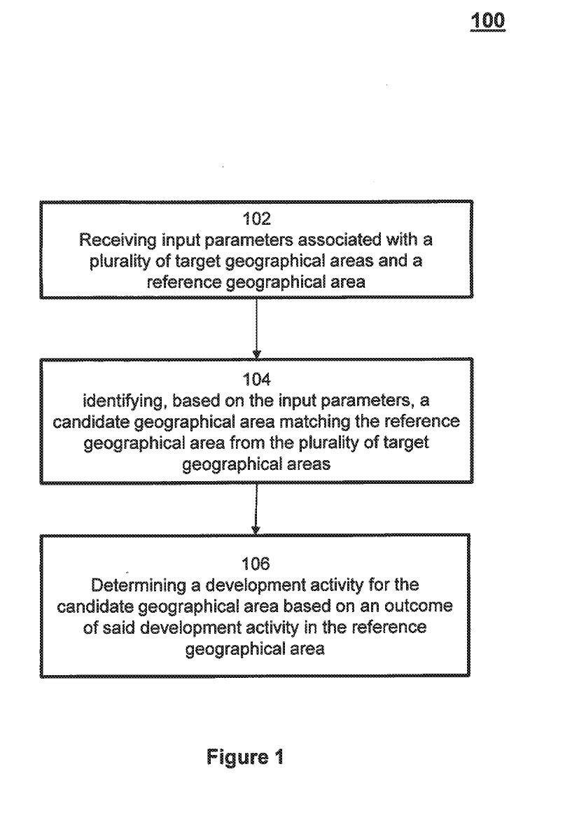

FIG. 1 shows a flow diagram 100 illustrating a method for determining a development plan for an area according to an example embodiment. For example, city officials of a city would like to consider which district should be selected to adopt smart city technologies, or which neighborhood should have a shopping mall. At step 102, input parameters associated with a plurality of target geographical areas and a reference geographical area are received at a server, e.g., one maintained by a service provider to the city government. The input parameters may be based on payment card transaction data originating from respective target geographical areas and reference geographical area. For example, the input parameters may include one or more of merchant-based spending matrices, affluence indicators of residents, and lifestyle indicators of residents of the target geographical areas and reference geographical area.

The target geographical areas include potential sites or locations for development in the same city, whereas the reference geographical area has undergone the proposed development and may be from the same city or another city. In the present method, to determine the likelihood of success of the proposed development, input parameters associated with the plurality of target geographical areas include data from a first time period and the input parameters associated with the reference geographical area include data from a second time period before the first time period. For example, the transaction data for the target geographical areas may be relatively current (e.g., last month/week on record), whereas the transaction data for the reference geographical area may be from the past, e.g., the month/week before the development was carried out.

At step 104, based on the input parameters, a candidate geographical area matching the reference geographical area is identified from the plurality of target geographical areas. For example, the matching may be carried out by comparing a composite score of each target geographical area with that of the reference geographical area to determine the closest match, with the score being generated from a regression model as described in further details below.

At step 106, a development activity for the candidate geographical area is determined based on an outcome of that development activity in the reference geographical area. For example, an infrastructure improvement to the candidate geographical area may be considered most optimal use of resources, and hence recommended to the city officials, if the same infrastructure improvement has been considered a success in the reference geographical area. Such improvement may include, e.g., installing intelligent lighting, installing a parking lot recommender, or installing remote metering.

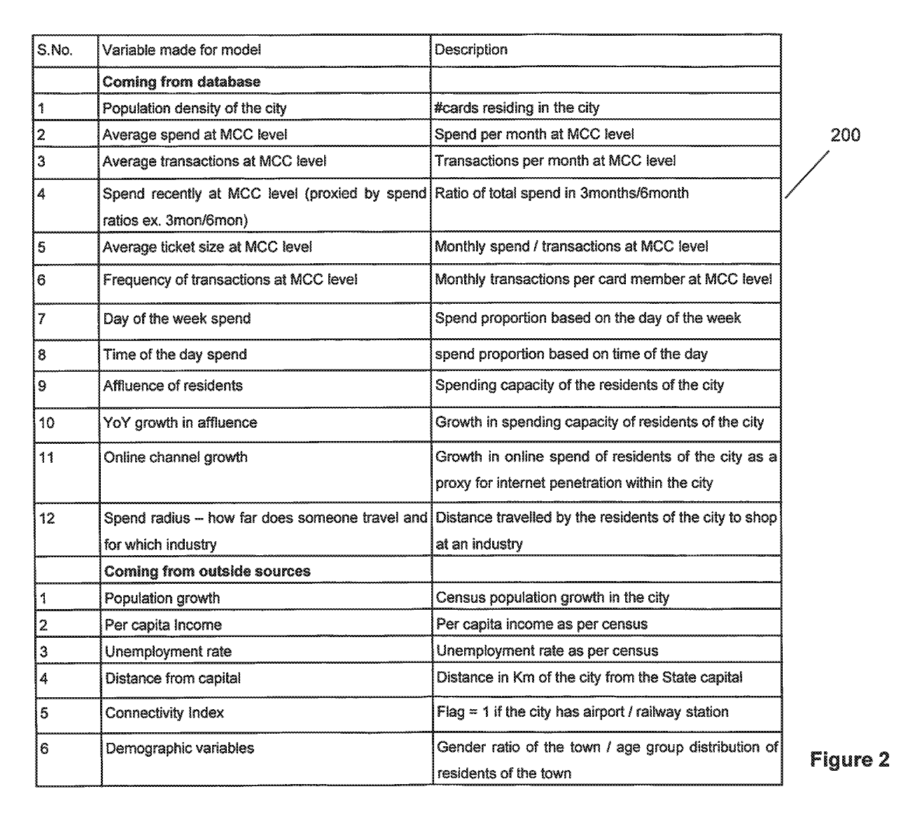

In the following, further details of an example implementation of the method of FIG. 2, in the context of developing smart cities, will be described.

In this example, a logistic regression model is developed to calculate the composite scores of the respective target geographical areas and reference geographical area for comparison and for identification of the candidate geographical area (step 104 of FIG. 1) and subsequent determination of the development activity (step 106 of FIG. 1).

Logistic regression may generally be used where the dependent variable is Binary or Dichotomous. That means the dependent variable can take only two possible values, such as “Yes or No”, “Default or No Default”, “Living or Dead”, “Responder or Non Responder”, “Yes or No”, etc. The independent factors or variables can be categorical or numerical variables.

The underlying algorithm of Maximum Likelihood Estimation (MLE) determines the regression coefficient for the model that accurately predicts the probability of the binary dependent variable. The algorithm stops when the convergence criterion is met or a maximum number of iterations is reached. Since the probability of any event lies between 0 and 1 (or 0% to 100%), when we plot the probability of dependent variable by independent factors, it will demonstrate an ‘S’ shape curve.

If the relationship between the independent and dependent variables is not linear but shows an ‘S’ shape, a linear model is not suitable to predict a probability of a certain outcome of the dependent variable. A Logit transformation of the dependent variable is required to make the correlation between the independent and dependent variables linear.

Logit Transformation is defined as follows:

Logit=Log(p/1−p)=log(probability of event happening/probability of event not happening)=log(Odds)

Now we can model using regression to predict the probability of a certain outcome of the dependent variable. The regression equation that the model will try to come out is:

Log(p/1−p)=b0+b1*x1+b2*x2+e

Where b0 is the Y intercept, e is the error in the model, b1 is the coefficient (slope) for independent factor x1, and b2 is the coefficient (slope) for independent factor x2, and so on. It is noted that there can be multiple independent factors.

As described above, in the first step, input parameters or variables for the regression model are received, e.g., from a database of a payment card network and/or from government agencies, such as the statistics bureau. FIG. 2 shows a table 200 listing the variables used for modelling according to one scenario.

Based on the data of table 200, the input parameters/variables may come in different forms, e.g., an absolute value, a ratio, a percentage. In the next step, standardization and normalization may be carried out to bring all parameters to a common scale.

According to various embodiments, a method to standardize a variable var may be as follows:

A. Determine mean(var) as M.

B. Determine standard deviation(var) as s.

C. Standardized variable (stan_var)=(var−M)/s.

The same method may be used to standardize all other variables.

The standardized variables may have mean 0 and standard deviation 1, but different ranges.

Next, the variables may be normalized, which may confine the variable between 0 and 1 and treat very small and very large values.

According to various embodiments, a method to normalize variable stan_var (obtained after standardization) may be as follows:

Norm_var=1/(1+exp(−stan_var)).

The Norm_var may be normalized with values between 0 and 1.

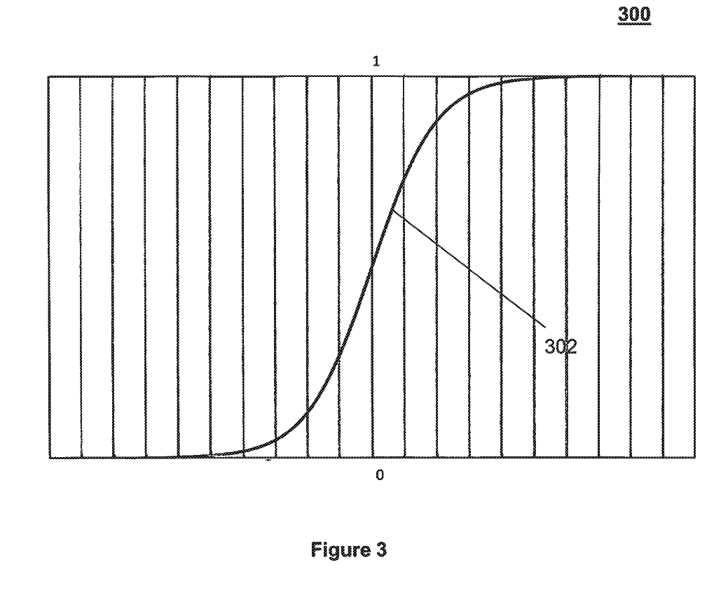

A graphical representation for normalization function is shown in illustration 300 of FIG. 3. As can be seen from FIG. 3, the normalization function is in the form of an ‘S’ shape curve 302 having values between 0 and 1. In other words, the parameters have been converted to a form that can be used in a logistic regression model as described above.

In the next step, a reduced set of distinguishing parameters to be used in the logistic regression model is identified from the input parameters. In smart city development context, this process identifies features/attributes which look most like how smart cities were in T-1 time period.

For example, a list of N existing smart cities may be identified. Their features in T-1 time period may be used to extract features for identifying future smart cities.

For another list of M target cities, their features in T time period may be used and matched with the features of N smart cities.

Variables listed in Table 1 may be determined for these N+M cities.

These N+M cities and their variables may be used to identify differentiating variables to be a logistic regression model.

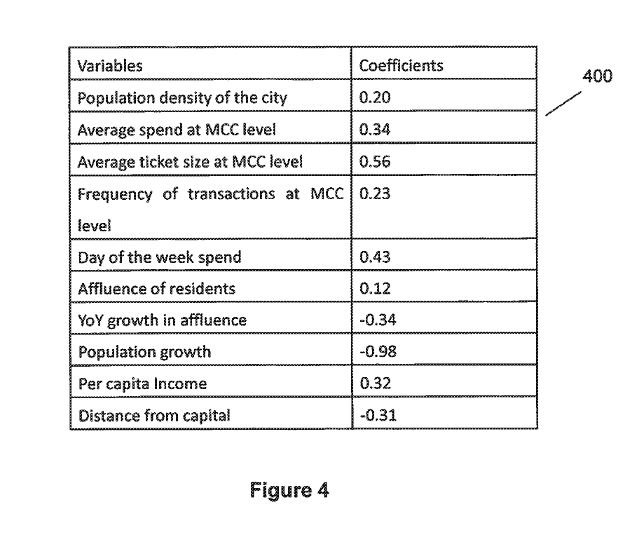

The result may be a list of differentiating variables and their coefficients. An illustrative output based on a hypothetical scenario is shown in FIG. 4.

In FIG. 4, the distinguishing variables or parameters listed in table 400 have normalized values between 0 and 1. Further, it is noted that some parameters positively correlate while other parameters negatively correlate. The set of distinguishing parameters may vary depending on the type of development being proposed. For example, the distinguishing parameters for developing smart cities may be different from those for reducing racial or religious segregation.

An exemplary model equation based on table 400 may be as follows: population density of the city*0.2+Average spend at MCC level*0.34+Average ticket size at MCC level*0.56+Frequency of transactions at MCC level*0.23+Day of the week spend*0.43+Affluence of residents*0.12+YoY growth in affluence*(−0.34)+Population growth*(−0.98)+Per capita Income*0.32+Distance from capital*(−0.31).

In this example, a propensity of becoming a smart city may be determined to be 1/(1+exp(−xbeta)). xbeta may refer to the logistic regression model equation that is estimated in the method described above. x may be the independent variables and beta may be the coefficients/weights assigned to the independent variables. In other words, xbeta may be the product of x (independent variables) and beta (coefficients/weights).

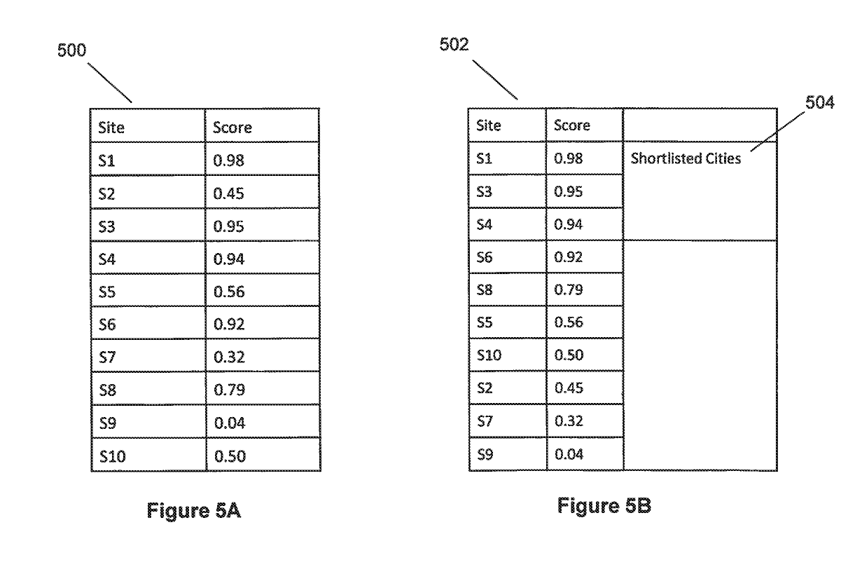

Next, the modelling equation obtained may be applied to all potential cities (targets) to calculate a composite score for each city. Illustrative results are shown in FIG. 5A, which shows a table 500 of potential cities and their respective scores which are not sorted.

Then these cities may be sorted (i.e., ranked) in descending order of score obtained, like shown in FIG. 5B, which shows a table 502 of ranked scores.

From the ranked scores, shortlisted cities 504, e.g., the top 3 cities with the highest score, may be identified for further consideration. The number of shortlisted cities 504 may be decided based on funds available. In other words, the present method allows for prioritization depending on the available resources.

The scores for these selected target cities may be matched with the scores obtained in the logistic function for the s smart cities.

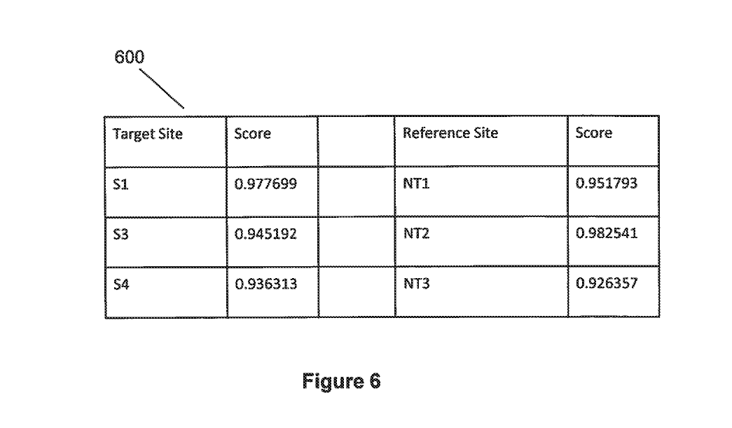

The smart city with which the score is closest to may be used as a model for developing the selected target city. FIG. 6 shows a table 600 illustrating an exemplary evaluation.

As illustrated in table 600, target site/city S1's score may be closest to reference site NT2, so S1's smart city development plan may mirror NT2's plan taken in the past.

Similarly, S3's plan may mirror NT1's, and S4's plan may mirror NT3's.

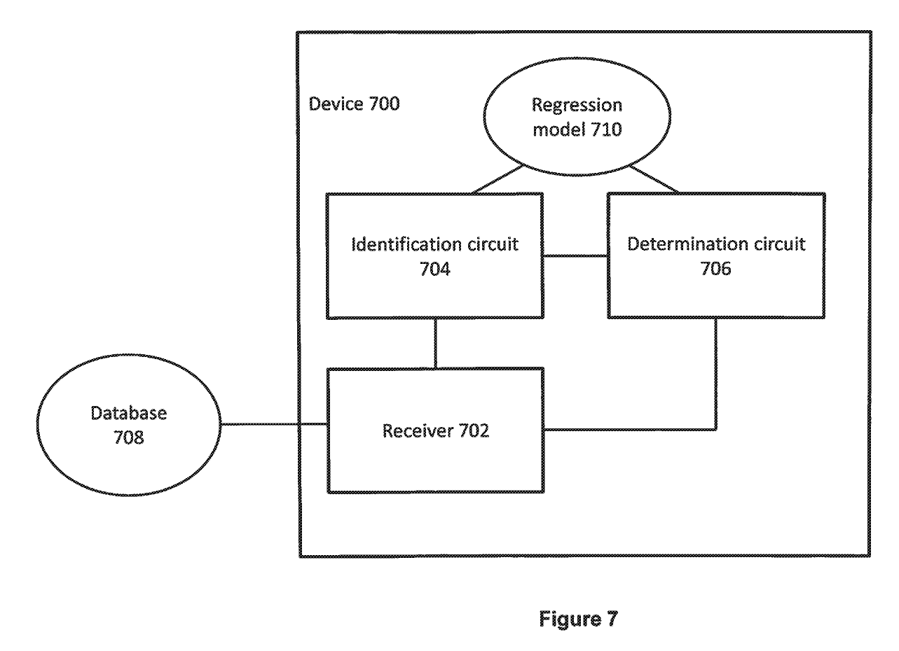

FIG. 7 shows a schematic diagram illustrating a device 700 for determining a development plan for an area according to an example embodiment. The device 700 includes a receiver 702, an identification circuit 704 and a determination circuit 706 in communication with each other. The receiver 702 is also in communication with a database 708 storing payment card data, such as one maintained by a payment card network. In use, the receiver 702 is configured to receive input parameters associated with a plurality of target geographical areas and a reference geographical area in the form of payment card transaction data originating from respective target geographical areas and reference geographical area. The identification circuit 704 is configured to identify, based on the input parameters, a candidate geographical area matching the reference geographical area from the plurality of target geographical areas. For example, the identification circuit uses a regression model 710 to calculate a score for each of the target geographical areas and reference geographical area, and selects the target geographical area having the score closest to that of the reference geographical area as the candidate geographical area, as described in further details below. The determination circuit 706 is configured to determine a development activity for the candidate geographical area based on an outcome of that development activity in the reference geographical area.

In an alternate embodiment, the device 700 of FIG. 7 can be implemented as part of a computer system, e.g., a server maintained by a payment card network. Such a computer system includes at least a processor and a memory unit in communication with the processor. The memory unit is configured to receive, e.g., from a data storage unit, input parameters associated with a plurality of target geographical areas and a reference geographical area. The processor is configured to identify, based on the input parameters, a candidate geographical area matching the reference geographical area from the plurality of target geographical areas, and determine a development activity for the candidate geographical area based on an outcome of said development activity in the reference geographical area.

According to the method, device and system as described, the location/site for development, as well as the strategy to use for its development may be recommended. Such a strategy makes use of real-world commercial data and may accurately reflect the socio-economic benefits of the development to all the residents of the geographical location, especially as the assessment is based on multiple categories. Some examples of infrastructure development that may benefit from such a strategy include efficient power management (for example, installing intelligent street lights), efficient sanitation systems (for example, estimating real time level of fullness of dustbin containers), and/or traffic control (for example, smart traffic lights which can adjust to avoid traffic congestion).

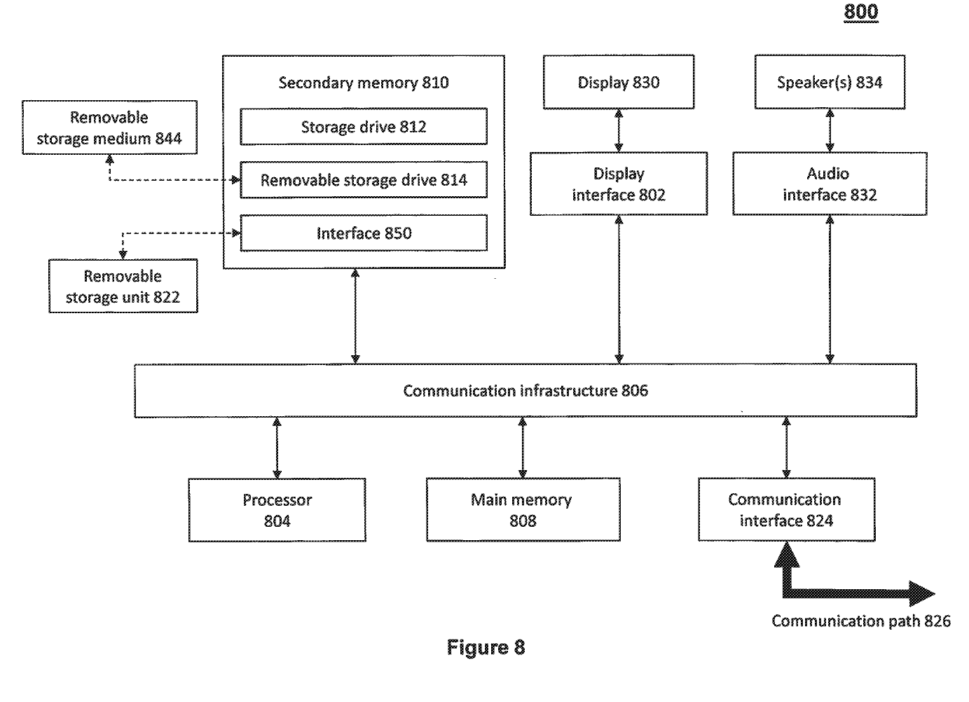

FIG. 8 depicts an exemplary computing device 800, hereinafter interchangeably referred to as a computer system 800 or as a server 800, where one or more such computing devices 800 may be used to implement the device 700 shown in FIG. 7. The following description of the computing device 800 is provided by way of example only and is not intended to be limiting.

As shown in FIG. 8, the example computing device 800 includes a processor 804 for executing software routines. Although a single processor is shown for the sake of clarity, the computing device 800 may also include a multi-processor system. The processor 804 is connected to a communication infrastructure 806 for communication with other components of the computing device 800. The communication infrastructure 806 may include, for example, a communications bus, cross-bar, or network.

The computing device 800 further includes a main memory 808, such as a random access memory (RAM), and a secondary memory 810. The secondary memory 810 may include, for example, a storage drive 812, which may be a hard disk drive, a solid state drive or a hybrid drive and/or a removable storage drive 814, which may include a magnetic tape drive, an optical disk drive, a solid state storage drive (such as a USB flash drive, a flash memory device, a solid state drive or a memory card), or the like. The removable storage drive 814 reads from and/or writes to a removable storage medium 844 in a well-known manner. The removable storage medium 844 may include magnetic tape, optical disk, non-volatile memory storage medium, or the like, which is read by and written to by removable storage drive 814. As will be appreciated by persons skilled in the relevant art(s), the removable storage medium 844 includes a computer readable storage medium having stored therein computer executable program code instructions and/or data.

In an alternative implementation, the secondary memory 810 may additionally or alternatively include other similar means for allowing computer programs or other instructions to be loaded into the computing device 800. Such means can include, for example, a removable storage unit 822 and an interface 850. Examples of a removable storage unit 822 and interface 850 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 822 and interfaces 850 which allow software and data to be transferred from the removable storage unit 822 to the computer system 800.

The computing device 800 also includes at least one communication interface 824. The communication interface 824 allows software and data to be transferred between computing device 800 and external devices via a communication path 826. In various embodiments of the disclosures, the communication interface 824 permits data to be transferred between the computing device 800 and a data communication network, such as a public data or private data communication network. The communication interface 824 may be used to exchange data between different computing devices 800 which such computing devices 800 form part an interconnected computer network. Examples of a communication interface 824 can include a modem, a network interface (such as an Ethernet card), a communication port (such as a serial, parallel, printer, GPIB, IEEE 1394, RJ45, USB), an antenna with associated circuitry, and the like. The communication interface 824 may be wired or may be wireless. Software and data transferred via the communication interface 824 are in the form of signals which can be electronic, electromagnetic, optical or other signals capable of being received by communication interface 824. These signals are provided to the communication interface via the communication path 826.

As shown in FIG. 8, the computing device 800 further includes a display interface 802 which performs operations for rendering images to an associated display 830 and an audio interface 832 for performing operations for playing audio content via associated speaker(s) 834.

As used herein, the term “computer program product” (or computer readable medium, which may be a non-transitory computer readable medium) may refer, in part, to removable storage medium 844, removable storage unit 822, a hard disk installed in storage drive 812, or a carrier wave carrying software over communication path 826 (wireless link or cable) to communication interface 824. Computer readable storage media (or computer readable media) refers to any non-transitory, non-volatile tangible storage medium that provides recorded instructions and/or data to the computing device 800 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card, such as a PCMCIA card, and the like, whether or not such devices are internal or external of the computing device 800. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites, and the like.

The computer programs (also called computer program code) are stored in main memory 808 and/or secondary memory 810. Computer programs can also be received via the communication interface 824. Such computer programs, when executed, enable the computing device 800 to perform one or more features of embodiments discussed herein. In various embodiments, the computer programs, when executed, enable the processor 804 to perform features of the above-described embodiments. Accordingly, such computer programs represent controllers of the computer system 800.

Software may be stored in a computer program product and loaded into the computing device 800 using the removable storage drive 814, the storage drive 812, or the interface 850. The computer program product may be a non-transitory computer readable medium. Alternatively, the computer program product may be downloaded to the computer system 800 over the communications path 826. The software, when executed by the processor 804, causes the computing device 800 to perform functions of embodiments described herein.

It is to be understood that the embodiment of FIG. 8 is presented merely by way of example. Therefore, in some embodiments, one or more features of the computing device 800 may be omitted. Also, in some embodiments, one or more features of the computing device 800 may be combined together. Additionally, in some embodiments, one or more features of the computing device 800 may be split into one or more component parts. The main memory 808 and/or the secondary memory 810 may serve(s) as the memory for the system; while the processor 804 may serve as the processor of the system.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the described method(s).

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, such as e.g., Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for determining a development plan for an area, the method comprising:
receiving, by at least one computing device, input parameters associated with a plurality of target geographical areas and a reference geographical area;
identifying, by the at least one computing device, based on the input parameters, a candidate geographical area matching the reference geographical area from the plurality of target geographical areas; and
determining, by the at least one computing device, a development activity for the candidate geographical area based on an outcome of said development activity in the reference geographical area.

2. The method of claim 1, wherein the input parameters associated with the plurality of target geographical areas comprise data from a first time period and the input parameters associated with the reference geographical area comprise data from a second time period before the first time period.

3. The method of claim 1, wherein the input parameters are generated based on payment card transaction data originating from respective target geographical areas and reference geographical area.

4. The method of claim 1, wherein the input parameters comprise one or more of merchant-based spending matrices, affluence indicators of residents, and lifestyle indicators of residents of the target geographical areas and reference geographical area.

5. The method of claim 1, wherein identifying the candidate geographical area comprises:
calculating a score for each of the target geographical areas and reference geographical area; and
selecting the target geographical area having the score closest to that of the reference geographical area as the candidate geographical area.

6. The method of claim 5, further comprising ranking the scores of the plurality of target geographical areas.

7. The method of claim 5, wherein calculating the score comprises:
identifying a set of distinguishing parameters from the input parameters; and
calculating the score based on a logistic regression model of the set of distinguishing parameters.

8. The method of claim 1, wherein the development activity comprises an infrastructure improvement to the candidate geographical area and the outcome of the development activity comprises a success.

9. A device for determining a development plan for an area, the device comprising:
a receiver configured to receive input parameters associated with a plurality of target geographical areas and a reference geographical area, wherein the receiver is in communication with a database storing payment card data;
an identification circuit configured to identify, based on the input parameters, a candidate geographical area matching the reference geographical area from the plurality of target geographical areas; and
a determination circuit configured to determine a development activity for the candidate geographical area based on an outcome of said development activity in the reference geographical area.

10. The device of claim 9, wherein the input parameters associated with the plurality of target geographical areas comprise data from a first time period and the input parameters associated with the reference geographical area comprise data from a second time period before the first time period.

11. The device of claim 9, wherein the input parameters are generated based on payment card transaction data originating from respective target geographical areas and reference geographical area.

12. The device of claim 9, wherein the input parameters comprise one or more of merchant-based spending matrices, affluence indicators of residents, and lifestyle indicators of residents of the target geographical areas and reference geographical area.

13. The device of claim 9, wherein the identification circuit is configured to calculate a score for each of the target geographical areas and reference geographical area, and select the target geographical area having the score closest to that of the reference geographical area as the candidate geographical area.

14. The device of claim 13, wherein the identification circuit is further configured to rank the scores of the plurality of target geographical areas.

15. The device of claim 13, wherein the identification circuit is further configured to identify a set of distinguishing parameters from the input parameters, and calculate the score based on a logistic regression model of the set of distinguishing parameters.

16. The device of claim 9, wherein the development activity comprises an infrastructure improvement to the identified target geographical area and the outcome of the development activity comprises a success.

17. A system for determining a development for an area, the system comprising:
a processor; and
a memory unit in communication with the processor;
wherein the memory unit is configured to receive input parameters associated with a plurality of target geographical areas and a reference geographical area;
wherein the processor is configured to:
identify, based on the input parameters, a candidate geographical area matching the reference geographical area from the plurality of target geographical areas; and
determine a development activity for the candidate geographical area based on an outcome of said development activity in the reference geographical area.
